(19) United States
(12) Patent Application Publication
(10) Pub. No.: US 2006/0269075 A1
(43) Pub. Date: Nov. 30, 2006

(54) Information processing apparatus and sound output characteristic adjusting method

(75) Inventor: Masahiko Takakusaki, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/443,340

(22) Filed: May 31, 2006

(30) Foreign Application Priority Data
May 31, 2005 (JP) 2005-160665

(51) Int. Cl. H04R 29/00

(52) U.S. Cl. 381/59

(57) ABSTRACT

According to one embodiment, an information processing apparatus comprises a memory section which stores plural types of output characteristic information that correspond to plural types of speakers, a main body on which one type of the plural types of speakers is mounted, a detector section which detects a type of the speaker mounted on the main body, means for selecting one from among the plural types of output characteristic information on the basis of a result of the detection, and an audio controller which adjusts frequency characteristics of an audio signal to be supplied to the speaker in accordance with the selected output characteristic information.

### CROSS-REFERENCE TO RELATED APPLICATIONS

This application is based upon and claims the benefit of priority from Japanese Patent Application No. 2005-160665, filed May 31, 2005, the entire contents of which are incorporated herein by reference.

### BACKGROUND

1. Field

One embodiment of the invention relates to an information processing apparatus and a sound output characteristic adjusting method for reproducing an audio in accordance with equalizer characteristics compatible with a speaker.

2. Description of the Related Art

Frequency characteristics of a sound to be outputted from a speaker are often different depending on the type of a speaker. In order to output a sound having flat frequency characteristics, it is preferable that frequency characteristics of an audio signal to be supplied to a speaker are adjusted in accordance with the type of the speaker.

In Jpn. Pat. Appln. KOKAI Publication No. 2001-197585, there is described that, in order to adjust frequency characteristics, frequency characteristics of test voice data outputted from a speaker are measured by a spectrum analyzer, and equalizer setting (EQ settings) for flattening the frequency characteristics of a sound to be outputted from speakers are generated based on a result of the measurement.

In the meantime, in the case of a personal computer, it is thought that assembling is carried out while the type of a speaker is changed according to a user's preference. Therefore, it is necessary to change EQ settings in accordance with a mounted speaker.

In order to change the EQ characteristics, it is thought to use a method in which a register which stores EQ settings for defining the frequency characteristics is provided in an audio controller and the frequency characteristics are directly changed by an audio CODEC. Then, EQ settings are provided to an audio driver of an operating system to be installed, and the change of the frequency characteristics is achieved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of a notebook type personal computer provided as an information processing apparatus according to a first embodiment;

FIG. 2 is an exemplary block diagram depicting a system configuration of the personal computer shown in FIG. 1;

FIG. 3 is an exemplary block diagram depicting a configuration relating to a sound output of the personal computer shown in FIG. 1;

FIG. 4 is an exemplary diagram for explaining a method of recognizing the type of a speaker;

FIG. 5 is an exemplary flow chart showing procedures in an EQ setting method according to the first embodiment;

FIG. 6 is an exemplary block diagram depicting a configuration relating to a sound output of a personal computer according to a second embodiment;

FIG. 7 is an exemplary flow chart showing procedures in an EQ setting method according to the second embodiment;

FIG. 8 is an exemplary flow chart showing procedures in an EQ setting method according to the second embodiment;

FIG. 9 is an exemplary block diagram depicting a configuration relating to a sound output of the personal computer according to the second embodiment;

FIG. 10 is an exemplary flow chart showing procedures in an EQ setting method according to a third embodiment; and

FIG. 11 is an exemplary flow chart showing procedures in an EQ setting method according to the third embodiment.

### DETAILED DESCRIPTION

Various embodiments according to the invention will be described hereinafter with reference to the accompanying drawings. In general, according to one embodiment of the invention, an information processing apparatus comprises a memory section which stores plural types of output characteristic information that correspond to plural types of speakers, a main body on which one type of the plural types of speakers is mounted, a detector section which detects a type of the speaker mounted on the main body, selecting section configure to select one from among the plural types of output characteristic information on the basis of a result of detection of the detector section, and an audio controller which adjusts frequency characteristics of an audio signal to be supplied to the speaker in accordance with the selected output characteristic information.

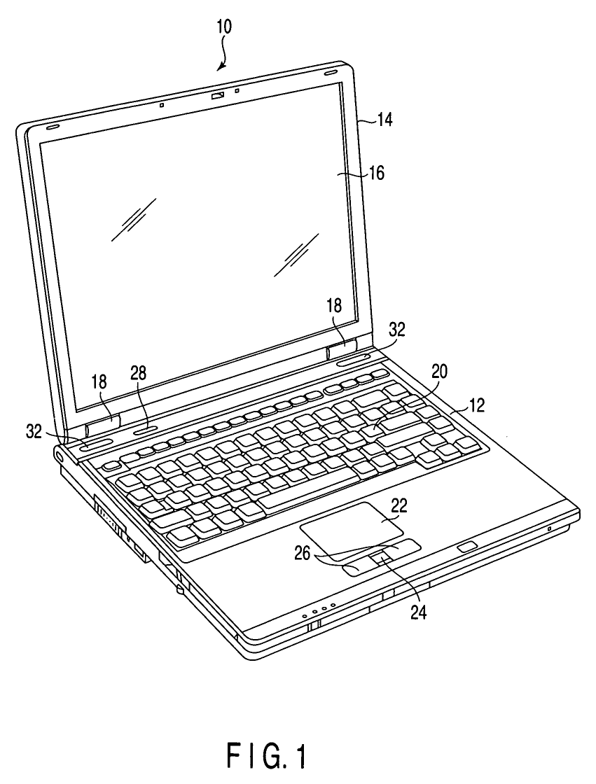

FIG. 1 is a view showing a configuration of a notebook type personal computer provided as an information processing apparatus according to a first embodiment.

The personal computer 10 is composed of a computer main body 12 and a display unit (display section) 14. The display unit 14 incorporates: a liquid crystal display (LCD) 16 that is a display panel; a backlight (not shown) that is a light emitting section; and an inverter (not shown) for driving the backlight. The display unit 14 is mounted on a hinge (support section) 18 provided at an end on a depth side of the computer main body 12 so as to turnably move between an open position that covers a top face of the computer main body 12 and a closed position at which the top face of the computer main body 12 is exposed.

The computer main body 12 has a thin box shaped casing, and a keyboard 20 is provided at an upper center part of the casing. A palm rest is formed on a top face of the casing portion in front of the computer main body 12. A touch pad 22, a scroll button 24, and touch pad control buttons 26 are provided at a substantial center part of the palm rest. A power button 28 for turning ON/OFF power supply of the computer main body 12 and left and right speakers 32 are allocated on the top face of the casing portion at the depth side of the computer main body 12. In the case of the present embodiment, one type of speaker 32 selected from among the two types of speakers is mounted in the computer main body 12.

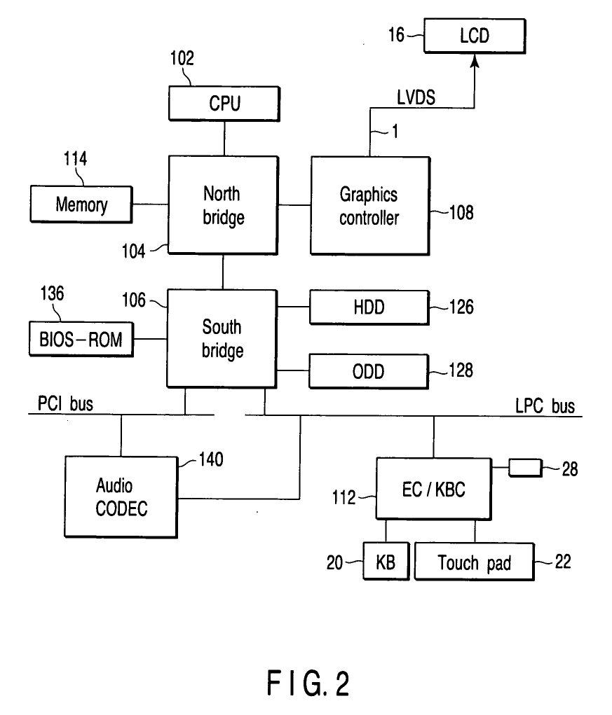

Now, a system configuration of this computer will be described with reference to FIG. 2.

The computer, as shown in FIG. 2, comprises a CPU 102, a north bridge 104, a main memory 114, a graphics controller 108, a south bridge 106, a BIOS-ROM 136, a hard disk drive (HDD) 126, an optical disk drive (ODD) 128, an audio CODEC 140, and an embedded controller/keyboard controller IC (EC/KBC) 112, etc.

The CPU 102 serves as a processor provided in order to control an operation of the computer. The CPU executes an operating system (OS) and a variety of application programs to be loaded from the hard disk drive (HDD) 126 to the main memory 114.

The CPU 102 also executes a system BIOS (Basic Input Output System) stored in the BIOS-ROM 136. The system BIOS serves as a program for hardware control.

The north bridge 104 servers as a bridge device for making connection between a local bus and a south bridge 106 of the CPU 102. The north bridge 104 incorporates a memory controller for controlling an access to the main memory 114 as well. Further, the north bridge 104 has a function of executing communication with the graphics controller 108 via an accelerated graphics port (AGP) bus or the like.

The graphics controller 108 serves as a display controller for controlling the LCD 16 that is used as a display monitor of the computer. The graphics controller 108 has a video memory (VRAM), and generates a video signal that forms a display image to be displayed on the LCD 16 from among the display data depicted in the video memory in accordance with the OS/application program.

The audio CODEC 140 functions as an audio controller for supplying to a speaker an audio signal having demodulated music data stored in the hard disk drive 126, and then outputting a sound from the speaker. The audio CODEC also has a function of encoding an analog audio inputted from the outside.

As described previously, the speaker 32 selected from a plurality of speaker types is mounted. The output frequency characteristics of the speaker are often different depending on the type of the speaker. Therefore, it is necessary to change output frequency (Equalizer (EQ)) characteristics of an audio signal supplied to the speaker in accordance with the type of speaker and its output frequency characteristics.

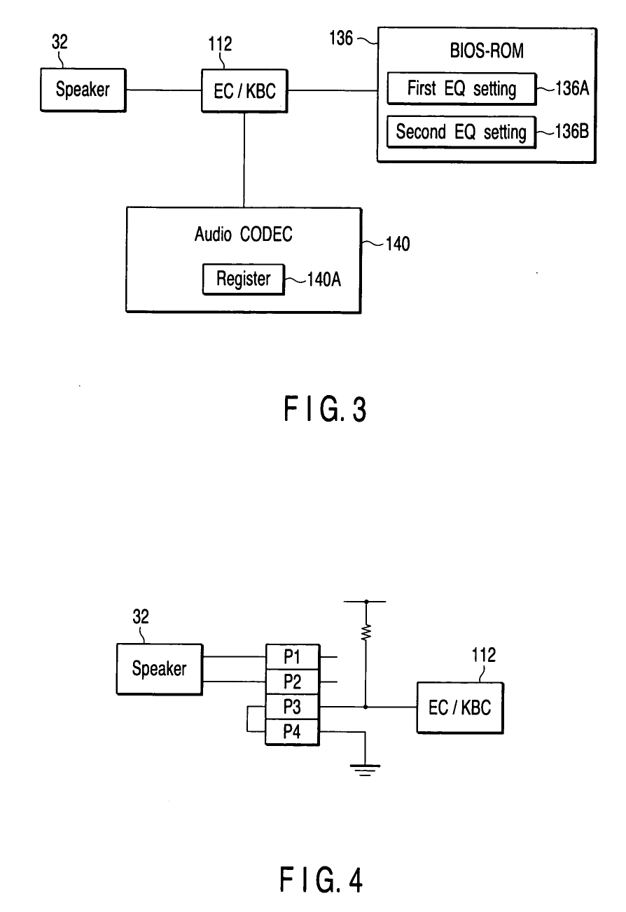

The apparatus according to the present embodiment, as shown in FIG. 3, stores a first EQ setting 136A and a second EQ setting 136B corresponding to two types of speakers that can be housed in the computer main body 12 incorporated in the BIOS-ROM 136. Then, the EC/KBC 112 recognizes the type of the speaker 32 at the time of boot processing of the personal computer 10. The EC/KBC 112 reads out the EQ setting according to the recognized speaker type from the inside of the BIOS-ROM 136, and writes the readout EQ setting in a resistor 140A incorporated in the audio CODEC 140, thereby setting the output frequency characteristics for the audio CODEC 140.

In order for the EC/KBC 112 to recognize the type of the speaker 32, a pair of pins for recognizing the speaker type is provided in a connector for supplying a voice signal to the speaker 32. As shown in FIG. 4, a first pin P1 and a second pin P2 are connected to an amplifier for outputting a voice signal. In addition, one of a pair of pins (third pin and fourth pin) P3 and P4, for example, the third pin P3 is connected to an input (for example, GPIO) of the EC/KBC 112, thereby carrying out a pull-up processing operation. Then, the other one of the pair of pins (third pin and fourth pin) P3 and P4, for example, the fourth pin P4 is connected to a ground. The third pin P3 and the fourth pin P4 are established in either one of an open (first speaker) state and a short (second speaker) state according to the type of the speaker.

In the case of the first speaker, the third pin P3 and the fourth pin P4 are open, and thus, an input to the EC/KBC 112 becomes high. Since in the case of the second speaker, the third pin P3 and the fourth pin P4 are shorted, the input to the EC/KBC 112 becomes low. In the case where an attempt is made to use two or more types of speakers, such an attempt can be achieved by increasing the number of EC input pins to a plurality of pairs.

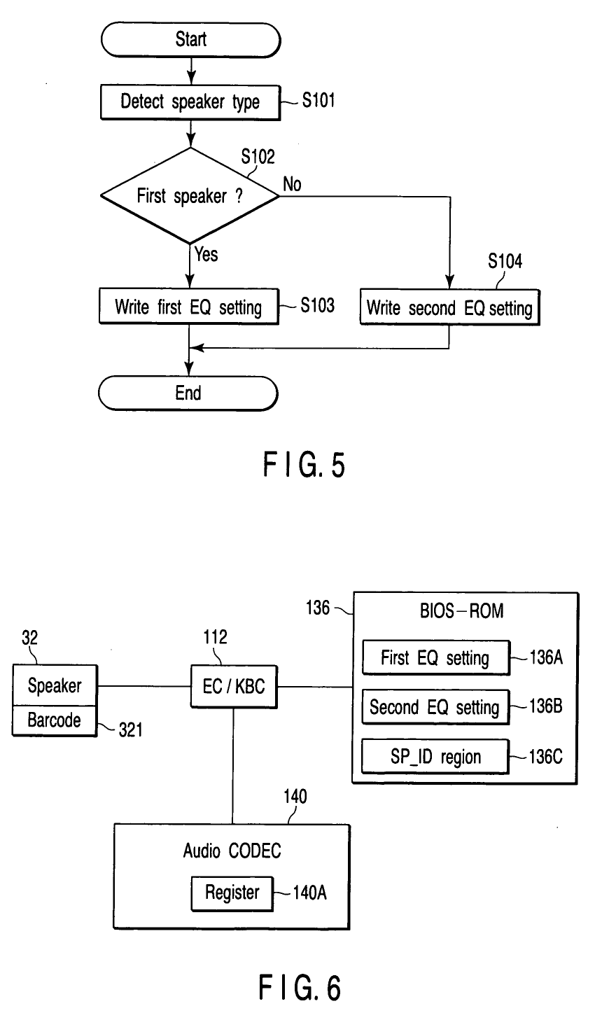

Now, a method for providing EQ settings of the audio CODEC 140 will be described with reference to a flow chart shown in FIG. 5. The following processing is carried out when the EC/KBC 112 initializes hardware connected thereto at the time of startup of the personal computer 10.

First, the EC/KBC 112 detects the type of the speaker provided at the computer main body 12 by checking whether a signal from the speaker 32 is high or low (block S101). In the case where the signal is high, it is detected that the mounted speaker is a first speaker. In the case where the signal is low, it is detected that the mounted speaker is a second speaker.

In the case where the first speaker is mounted (Yes in block S102), the EC/KBC 112 selects the first EQ setting 136A in the BIOS-ROM 136, and writes the first EQ setting 136A in the register 140A of the audio CODEC 140 via the LPC bus (block S103). In the case where the second speaker is mounted (No in block S102), the EC/KBC 112 selects the second EQ setting 136B in the BIOS-ROM 136, and writes the second EQ setting 136B in the register 140A of the audio CODEC 140 via the LPC bus (block S104).

The writing of the EQ setting into the register 140A in the audio CODEC 140 may be carried out by the BIOS-ROM 136 at the time of I/O initialization using the BIOS-ROM 136 instead of the EC/KBC 112.

According to the present embodiment, all the EQ settings compatible with mountable speakers are stored in the BIOS-ROM 136, whereby equalizer settings suitable to the frequency characteristics of the speakers can be easily incorporated at the time of manufacturing equipment for incorporating a speaker selected from plural types of speakers at the time of assembling. In addition, an optimal EQ setting is automatically selected without a user's awareness by automatically setting EQ setting after recognizing the type of the speaker at the time of startup of a personal computer.

(Second Embodiment)

FIG. 6 is a block diagram depicting a configuration relating to a sound output of a personal computer according to a second embodiment of the present invention.

As shown in FIG. 6, a plurality of EQ settings are stored in a BIOS-ROM (first storage device) 136 and a speaker ID region (third storage device) 136A capable of recording the type of a speaker is provided in the BIOS-ROM 136. At the time of assembling a personal computer 10, the type (information) of a speaker 32 is written into the speaker ID region 136C.

In order to recognize the type of a speaker at the time of assembling, a barcode 321 is attached to the speaker, and the barcode 321 is read, whereby information is automatically written into the speaker ID region 136C.

Then, after assembling, EQ setting is written into a register 140A (second storage device) of an audio CODEC 140 based on the information stored in the speaker ID region 136C every startup.

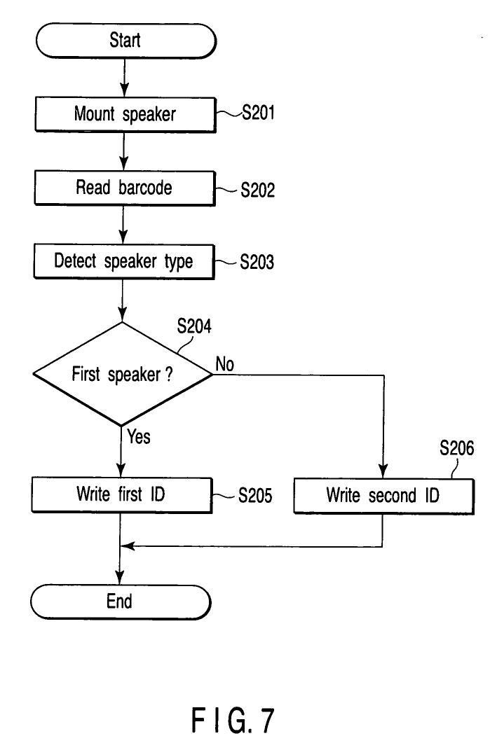

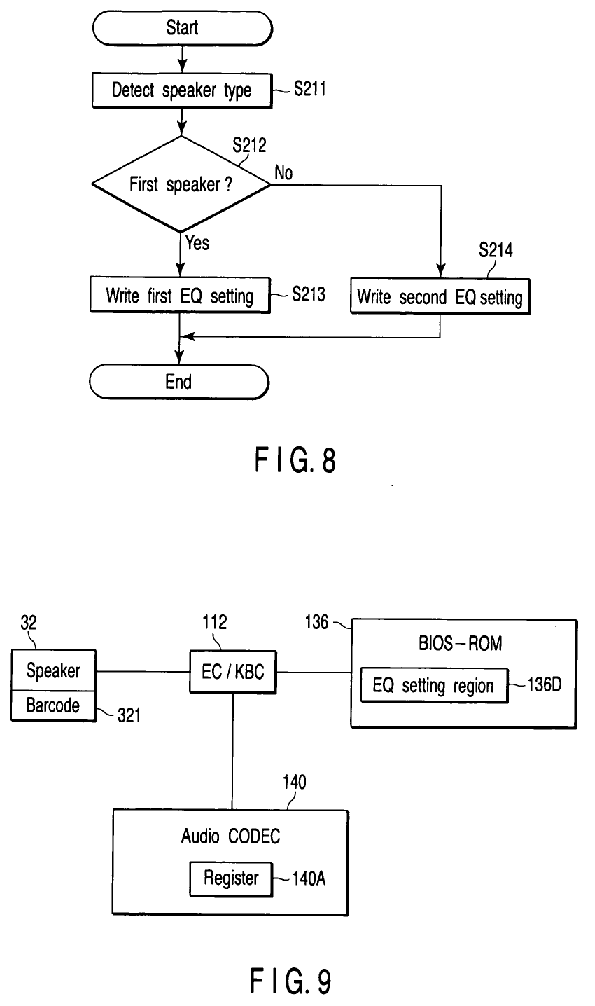

The procedures for processing operation described above will be described with reference to flow charts shown in FIGS. 7 and 8.

First, at the time of assembling, the speaker 32 having the barcode 321 attached thereto is mounted on the main body 12 (block S201). The barcode 321 attached to the speaker 32 is read by a barcode reader (block S202), and the type of the speaker 32 is detected (block S203). In the case where the detected type of the speaker 32 is a first speaker (Yes in block S204), a first ID setting corresponding to the first speaker is written into the speaker ID region 136C in the BIOS-ROM 136 (block S205). In the case where the detected type of the speaker 32 is a second speaker (No in block S304), a second ID corresponding to the second speaker is written into the speaker ID region 136C in the BIOS-ROM 136 (block S206). Thereafter, a keyboard 20 and the like are mounted, and a personal computer 10 is completed. The description of the processing at the time of assembling has now been completed.

Now, a description will be given with respect to a processing at the time of startup after a user has purchases the personal computer 10. First, the EC/KBC 112 detects the type of a speaker mounted on the computer main body 12 from the information stored in the speaker ID region 136C in the BIOS-ROM 136 (block S211).

In the case where the detected speaker type is a first speaker (Yes in block S212), the EC/KBC 112 selects a first EQ setting 136A in the BIOS-ROM 136, and writes the first EQ setting 136A in the register 140A of the audio CODEC 140 via the LPC bus (block S213). In the case where the detected speaker type is a second speaker (No in block S212), the EC/KBC 112 selects a second EQ setting 136B in the BIOS-ROM 136, and writes the second EQ setting 136B in the register 140A of the audio CODEC 140 (block S214).

The writing of the EQ setting into the register 140A in the audio CODEC 140 may be carried out by the BIOS-ROM 136 at the time of I/O initialization using the BIOS-ROM 136 instead of the EC/KBC 112.

In the case of the present embodiment, cost reduction can be achieved because no special connector is used to recognize the type of a speaker.

(Third Embodiment)

FIG. 9 is a block diagram depicting a configuration relevant to a sound output of a personal computer according to a third embodiment of the present invention.

In the present embodiment, at the time of assembling, the type of a speaker is detected, and then, a BIOS image having only the detected EQ setting is written into an EQ setting region (first storage device) 136D in a BIOS-ROM 136.

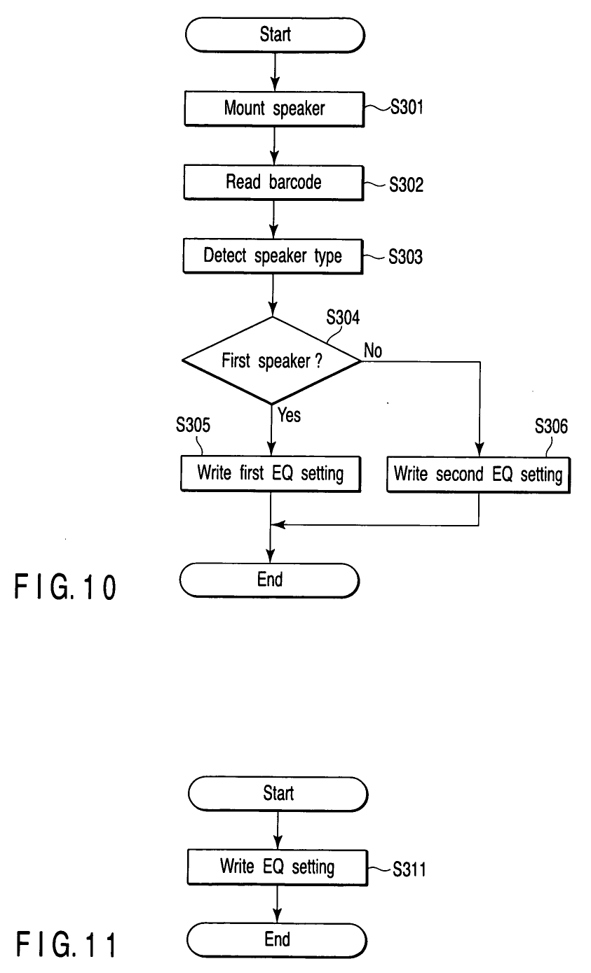

The procedures for this processing will be described with reference to a flow chart shown in FIG. 10.

First, at the time of assembling, a speaker 32 having a barcode 321 attached thereto is mounted on a main body 12 (block S301). The barcode 321 attached to the speaker 32 is read by a barcode reader (block S302), and the type of the speaker 32 is detected (block S303). In the case where the detected type of the speaker 32 is a first speaker (Yes in block S304), a first EQ setting corresponding to the first speaker is written into the EQ setting region 136D in the BIOS-ROM 136 (block S305). In the case where the detected type of the speaker 32 is a second speaker (No in block S304), a second EW setting corresponding to the second speaker is written into the EQ setting region 136D in the BIOS-ROM 136 (block S306).

After the EQ setting has been written into the EQ setting region 136D, a keyboard 20 and the like are mounted, and a personal computer 10 is completed. The description of the processing at the time of assembling has now been completed.

With reference to FIG. 11, a description will be given with respect to a processing at the time of startup after a user has purchased the computer 10. First, the EC/KBC 112 writes the EQ setting stored in the EQ setting region (first storage device) 136D in the BIOS-ROM 136 into a register (second storage device) 140A of an audio CODEC 140 via the LPC bus (block S311).

According to the present embodiment, a ROM region for one speaker type can suffice, and efficient use of the ROM region can be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage device which stores plural types of output characteristic information that correspond to plural types of speakers;
a main body on which one type speaker selected from the plural types of speakers is mounted;
a detector section which detects a type of the speaker mounted on the main body;
a selecting section which selects one from among the plural types of output characteristic information on the basis of a result of detection of the detector section; and
an audio controller which adjusts frequency characteristics of an audio signal to be supplied to the speaker mounted on the main body in accordance with the selected output characteristic information.

2. The information processing apparatus according to claim 1, wherein the speaker mounted on the main body comprises one or more pairs of pins set for opening or shorting in accordance with a speaker type, and the detector section is connected to one of the pair of pins.

3. An information processing apparatus comprising:
a first speaker mounted on a main body;
a first storage device which stores a first output characteristic information that corresponds to the first speaker;
a second storage device;
a writing unit configure to write the first output characteristic information stored in the first storage device to the second storage device; and
an audio controller which adjusts frequency characteristics of an audio signal to be supplied to the first speaker in accordance with the first output characteristic information stored in the second storage device.

4. The information processing apparatus according to claim 3, further comprising a third storage device to store a information that corresponds to the first speaker, wherein
the first storage device further stores a second output characteristic information corresponding to a second speaker, and
the writing unit configure to write the first output characteristic information in accordance with the information stored in the third storage device.

5. An information processing apparatus according to claim 3, wherein only the first output characteristic information corresponding to the first speaker is stored in the first storage device.

6. An information processing apparatus according to claim 3, wherein a barcode according to a speaker type is attached to the first speaker.

7. A sound output characteristic adjusting method of an information processing apparatus which comprises an audio controller configured to adjust frequency characteristics of an audio signal to be supplied to a speaker mounted on a main body in accordance with an output characteristic information stored in a first storage device, the method comprising:
detecting a type of the speaker mounted on the main body;
selecting a output characteristic information corresponding to a type of the speaker detected from the plural types of output characteristic information stored in a second storage device; and
storing the selected output characteristic information in the first storage device.

8. A sound output characteristic adjusting method according to claim 7, wherein the information processing apparatus comprises a third storage device stored information oh a type of the speaker mounted on the main body, and
the detection is carried out based on the speaker type information.

9. A sound output characteristic adjusting method according to claim 7, further comprises, reading a barcode according to a speaker type which attached to the speaker, detecting a type of speaker based on the read barcode, storing the speaker type information accordance with the detected speaker type in the first storage device.
